(19) United States
(12) Patent Application Publication
(10) Pub. No.: US 2012/0145945 A1
(43) Pub. Date: Jun. 14, 2012

(54) REAL TIME MONITORED SYNTHESIS OF ULTRA LOW COERCIVITY MAGNETIC NANOPARTICLES WITH NARROW SIZE DISTRIBUTION

(76) Inventors: Valter Strom, Spanga (SE); Richard Olsson, Lidingo (SE)

(21) Appl. No.: 13/384,428

(22) PCT Filed: Jul. 9, 2010
(86) PCT No.: PCT/SE2010/000190

§ 371 Date: Feb. 28, 2012

(30) Foreign Application Priority Data
Jul. 17, 2009 (SE) 0900996-0

(51) Int. Cl. H01F 1/06; B82Y 40/00; B82Y 30/00

(52) U.S. Cl. 252/62.53; 252/62.56; 977/773; 977/896

(57) ABSTRACT

A process for the production of magnetic nanoparticles on a continuous basis from aqueous salt solutions, utilizes very rapid mixing of the reaction components to achieve particles with a uniform size and shape as well as narrow size distribution. The process includes a methodology to determine the necessary experimental conditions to achieve a sufficiently rapid mix of the reaction components, based on real-time measurements of the magnetic susceptibility of the precipitate during the precipitation reaction.

### BACKGROUND OF THE INVENTION

Magnetic nanoparticles with large surface to bulk ratio and a diameter smaller than 100 nm have received attention for their current and future importance in applications such as magnetic data storage, magnetic sensors, ferrofluids, catalysts, cell separation, drug delivery, diagnostics and hyperthermia for cancer treatment.

In most of the applications of magnetic nanoparticles, it is crucial that the magnetic characteristics of the particles are tailored for their specific applications. As the magnetic properties are well known to be strongly dependant on the size of the particles (given a specific shape, elemental and phase composition) it is of utmost importance to precisely control and monitor the particle synthesis conditions/parameters to ensure that the projected particle sizes can be determined on beforehand, and that particles are obtained in a highly reproducible manner. For great many applications it is also desirable, or even of fundamental importance, to have uniform particle sizes, i.e. small spread of the sizes within a sample of particles so that the functional properties can be exploited in the applications as related to a specific particle size, i.e. as related to its magnetic characteristics. It is also of great importance to develop environmentally friendly, low-cost and efficient large-scale production methods, preferably synthesis methods that can be employed on a continuous basis.

A variety of process methods have been reported on the manufacture/synthesis of magnetic nanoparticles, such as; aqueous co-precipitation, thermal decomposition of organo-metallic precursors at elevated temperatures, micro-emulsion synthesis in organic media, polyol synthesis utilizing nobel metal grains/seeds, or even magnetic field assisted synthesis etc. However, the reported methods to generate magnetic nanoparticles with narrow size distributions are typically limited to batch wise production methods involving the use of toxic organic chemicals. Other reported methods are very costly in terms of extensive experimental set-ups, and/or require high energy in-put, or have demonstrated to generate not sufficiently narrow size distributions for the particle samples, thus seriously affecting the magnetic properties.

The aqueous co precipitation reaction is probably the most widespread method for the synthesis of magnetic nanoparticles. Here, an aqueous metal ion solution is mixed with an aqueous alkaline solution to provoke a precipitation of magnetic nanoparticles. Experimentally, aqueous co-precipitation is very easy to perform and requires neither any organic solvents nor but the most elementary laboratory equipment. The aqueous co-precipitation method is possibly the most environment friendly way to synthesis magnetic nanoparticles since it relies only on the use of water-based precipitation components. The method is also known to be suitable for large-scale production since it can be adjusted to work on a continuous basis. However, despite these distinct virtues it is often abandoned in favour of more complex synthesis methods (involving toxic chemicals) that yield more narrow particle size distributions.

Mostly, the vague interest in the aqueous co precipitation methodology can be explained as related to the complex nature of the aqueous co-precipitation reactions and a lack of methodologies to control and monitor the progress of different reactions stages. It is well documented in literature that a variety of different material phases are generated during the course of the aqueous co-precipitation reactions, i.e. as the magnetic nanoparticles nucleate and grow/develop with time towards their final size with a stable phase composition. This inevitably has made it very difficult to optimize physical as well as chemical reaction parameters so that the outcome of the precipitation reactions in terms of particle size, phase purity etc., can be predicted to great certainty on beforehand, i.e. prior to the synthesis. It is also well documented in the literature that aqueous co precipitation reactions typically generate magnetic nanoparticles with a significant variation in sizes of the particles.

So far no experimental setups have been presented that enables constant and continuous practical surveillance of the reaction routes (phase transformations) during aqueous co precipitation. Attempts have been made to follow the particles growth and development in time by occasional withdrawal of aliquots, but these investigations hardly gives the full picture of the reactions since phase transformations proceed continuously during the course of the reactions (after the initial stage of nucleation) until the most stable compound has developed. Neither do sample withdrawals give any insight into the time frame immediately after the mixing of the components nor have any experimental techniques been reported on how to obtain reliable data within the first few seconds of the reaction. Accordingly, it is presently not known whether the cause of the wide spread of particle sizes originate from the growth sequence involving the various existing phase transformation or is solely related to the initial nucleation when the precipitation components are mixed.

Therefore, there is a need within the technical field of magnetic nanoparticle synthesis to find methods to control and master the manufacture of magnetic nanoparticles by the aqueous co precipitation route. Methodologies to monitor the progress of the aqueous co-precipitation reactions during the full course of the reactions are missing. A methodology to monitor the co-precipitation during the course of the reaction would present a great advantage since it would render it possible to in a controlled manner finely adjust influencing parameters such as mixing rates, flow rates, growth times, as well as temperatures and media compositions etc. to favour synthesis of well defined magnetic nanoparticles with tailored sizes and narrow particle size distributions. A methodology to produce magnetic nanoparticles with specific sizes and narrow size distributions from aqueous solutions would also constitute a great advantage because it would be an environment friendly route to generate magnetic nanoparticles in absence of toxic organic constituents.

### SUMMARY OF THE INVENTION

The foregoing dilemma is solved by providing a methodology and a material according to the invention. It is therefore an object of the present invention to provide a methodology that enables continuous process monitoring (utilizing real time magnetic measurements), which allows for better control during the course of the reaction when aqueous co-precipitation of magnetic nanoparticles is performed. In a further aspect of the invention, there is provided a magnetic nanoparticle material showing a markedly more narrow size distribution and greatly improved magnetic properties, obtained by utilizing the invented methodology to establish accurate processing conditions during the aqueous co precipitation reaction.

It is therefore an advantage of the invention to provide a novel processing methodology that allows for manufacture of magnetic nanoparticles from aqueous ion solutions with uniform size and shape, and a more narrow size distribution than previously has been reported. Further, it is an advantage of the invention that the new methodology with experimental setup can be utilized for real-time magnetic measurements during the course of particle manufacture to ensure accurate processing conditions are obtained for the manufacture of nanoparticles with uniform size and shape. Further, the invention provides specific experimental conditions for co precipitation of magnetic nanoparticles that can be made on a continuous basis in a mixing device where a metal ion and an alkaline aqueous solution are rapidly mixed (RM), yielding nanoparticles with greatly improved magnetic properties as compared to when the same components are slowly mixed (SM) at mixing rates previously reported in the literature. Further, the real-time monitoring of the precipitation reaction can be used for systematic investigations on how different chemical and physical parameters affect precipitation outcome from different aqueous precipitation reactions of magnetic nanoparticles.

Another advantage of the invention is that the new methodology allows for precipitation of magnetic nanoparticles in a more environment friendly manner than what have previously been reported for similarly sized particles.

In one embodiment the new method provides possibilities to prepare very small superparamagnetic nanoparticles with an average size between 5 and 10 nm and a markedly more narrow size distribution than previously reported, yielding particles with extremely low coercivity and high magnetic saturation. Such magnetic nanoparticles are obtained by selecting the required metal ion solution composition, precipitate the nanoparticles under RM and systematically optimize the reaction conditions (chemical and physical) by utilizing the in-situ real time monitoring of the precipitation reaction.

In another embodiment, the new method provides possibilities to prepare magnetic nanoparticles with uniform sizes in the range 20-100 nm, sufficiently large to hold a maximum sized single magnetic domain in each particle, yielding particles with very high coercivity. Such magnetic nanoparticles are obtained by selecting the required metal ion solution composition, precipitate the nanoparticles under RM and systematically optimize the reaction conditions (chemical and physical) by utilizing the in-situ real time monitoring of the precipitation reaction.

The magnetic nanoparticle material can be used within a broad range of applications. To illustrate the broad application area a number of different applications are suggested below without being limited in any way. The magnetic nanoparticle material can be used within biomedical applications (diagnostics, hyperthermia for cancer treatment, targeted drug delivery, cell separation, magnetic filtration systems within pharmaceutical applications etc.) chemical analysis applications, separation applications, ferrofluids, catalysts, magnetic sensors, ultrahigh density magnetic data storage etc.

In a yet another embodiment the invention can be used in an extended experimental setup that allow for subsequent magnetic nanoparticle modifications such as surface modifications, ultrasonication, high temperature annealing, etc.

In addition, other advantages of the invention is that products based on the improved magnetic characteristics of the magnetic nanoparticle material can be provided; externally activated magnetic filtration set-ups, high-sensitivity magnetic membranes, magnetic films, magnetic foams based on nanoparticles, microwave absorbers, sensitive electromagnetic switches, generators etc.

The invention makes it possible to produce highly reproducible magnetic nanoparticle materials (at different occasions) on a continuous basis because the sensitive magnetic measurements from previous runs can be recorded and compared with real time magnetic measurements on subsequent runs.

It should be noted that even if the magnetic properties of the nanoparticles primarily are improved as related to the more even size of the magnetic nanoparticles, several other important material properties such as light scattering, catalytic performance, particle agglomeration etc can also benefit from more evenly sized particles.

Other objects and advantages of the present invention will become apparent from the following description and examples.

### DEFINITIONS

For purposes of this invention, the term “magnetic nanoparticle” is intended to encompass a particulate material with any shape wherein the finest dimension is smaller than 100 nm.

The term “average particle size” is intended to encompass the sum of the diameters of a minimum of 500 particles divided by the number of the particles. The diameters of the particles are manually measured as the cross-sectional distance form edge-to-edge, visible from transmission electron micrographs with a known reference scale bar.

The term “particle size distribution” is intended to encompass either “number size distribution ” or “volume size distribution”.

The term “number size distribution” is intended to encompass the frequency distribution that shows the number of particles found in each size range displayed in a histogram, where the Y-axis relates to the number of the particles in the columns and the X-axis display the diameter of the measured particles in the respective column

The term “volume size distribution” is intended to encompass the frequency distribution that shows the volume fraction of particles found in each size range displayed in a histogram, where the Y-axis relates to the volume fraction of the particles in the columns and the X-axis display the volume of the measured particles in the respective column

The term “mild oxidation agent” is intended to encompass any type of media that is capable of oxidizing ferrous ions to ferric ions to a sufficient extent that magnetic particles can be obtained (ferrites).

The term “transition metal ions” is intended to encompass metal ions such as all elements in the d-block of the periodic table that can be used to obtain iron oxide based magnetic nanoparticles, such as Manganese/Iron/Cobalt, Zinc etc.

The term “coordination compounds of d-block elements” is intended to encompass any compound including metal ions from d-block elements, such as hydroxides/oxides etc.

The term “alkaline solution” is intended to encompass aqueous solutions containing NaOH, KOH, LiOH, NH₃, and the like.

The term “metal hydroxide/oxide complex” is intended to encompass coordination complexes of metal ions that are created upon dissolving metal salts in a liquid aqueous phase.

The term “metal salt solution” is intended to encompass a solution of metal ions in water, such as Co²⁺, Fe²⁺, Fe³⁺, Mn²⁺ and the like, generated from the corresponding salts.

The term “in-phase susceptibility” designates the component of the magnetic alternating magnetic field (AC) susceptibility which is not phase-shifted with respect to the exciting alternating magnetic field.

The term “out-of-phase susceptibility” designates the component of the alternating magnetic field (AC) susceptibility which is 90° phase-shifted with respect to the exciting alternating magnetic field, thus constituting the component with energy losses.

### BRIEF DESCRIPTION OF THE DRAWINGS

FIG. 1. The mixing device without syringes and pneumatic actuator. Two small steel tubes are inserted into one end of a thin Teflon tube. This end of the tube is sealed.

FIG. 2. Scheme of the experimental set-up (except the pneumatic actuator). The mixed reactants are immediately directed into the sample vial in the magnetic AC susceptometer.

FIG. 3. Comparison of magnetic responses from rapid mixing (RM) and slow mixing (SM). At time 12 seconds, the two reactants are mixed and discharged into the susceptometer, where in-phase (left scale) and out-of-phase susceptibility (right scale) are measured. A RM results in a quick reaction largely completed within one minute after which the out-of-phase susceptibility becomes stationary at about 0.5%. The slow mix (SM) results in a much slower reaction, with a concomitant steadily increasing out-of-phase susceptibility even after 10 minutes.

FIG. 4. The hysteresis loops from a RM and a SM sample precipitated with NH₃. At this scale the coercivities are not discernible. Note the large magnetization values.

FIG. 5. A magnified measurement around origin displays a distinct difference in coercivity between RM (Hc=8.5 A/m) and SM (Hc=33.5 A/m).

FIG. 6. Precipitation with NaOH displays similar effect of mixing rate, i.e., the coercivity is distinctively smaller for RM as compared to SM.

FIG. 7. TEM micrograph of RM magnetite particles deposited on a grid from an ethanol solution after exchange of aqueous medium.

FIG. 8. TEM micrograph of SM magnetite particles deposited on a grid from an ethanol solution after exchange of aqueous medium. Note the decisive similarity to particles in FIG. 7.

FIG. 9. Number size distribution of RM and SM particles, displayed as number of particles versus size (size interpreted as maximum overall length). The RM average size is 6.4 nm, and the SM mean size is 7.4 nm.

FIG. 10. Volume size distribution. The volume fractions are displayed versus particle volume (assuming spherical particles with diameters equal to determined length). RM particles have a much narrower size spread.

### DETAILED DESCRIPTION OF THE INVENTION

In one aspect of the invention, there is provided magnetic nanoparticle material obtained by rapidly mixing the precipitation constituents (RM methodology) in a time frame of milliseconds, followed by a growth/crystallization period lasting until the in-phase and out-of-phase real time magnetic AC susceptibility measurements show constant values.

The magnetic nanoparticle material can be characterized as a collection of particles with an average particle size in the range between 5 and 10 nm (or larger, but smaller than 100 nm) and a number and volume size distribution with a markedly narrow size distribution, as a result of utilizing the experimental setup according to the invention.

The magnetic nanoparticle material can further be characterized to exhibit superparamagnetism, as determined by Langevin like hysteresis loop behaviour, or ferri/ferromagnetism hysteresis loop behavior at measurements in a commercial vibrating sample magnetometer (EG&G Princeton Applied Research VSM model 155 or similar).

In a further aspect of the invention, there is provided a methodology for forming the magnetic nanoparticle material under continuous real time monitoring of the particles' magnetic properties while utilizing the RM methodology, to ensure that sufficiently rapid mixing is performed. This methodology comprises the steps of:

a) preparing an aqueous solution of metal ions and an alkaline solution in 2 different containers, which on mixing results in precipitation of magnetic nanoparticles,

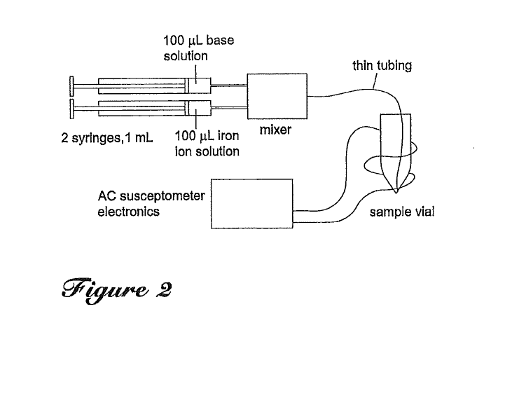

b) starting the data reading software connected to the AC magnetic susceptometer. The software reads data uninterrupted until stopped by the operator. FIG. 2 shows the relevant components in the experiment,

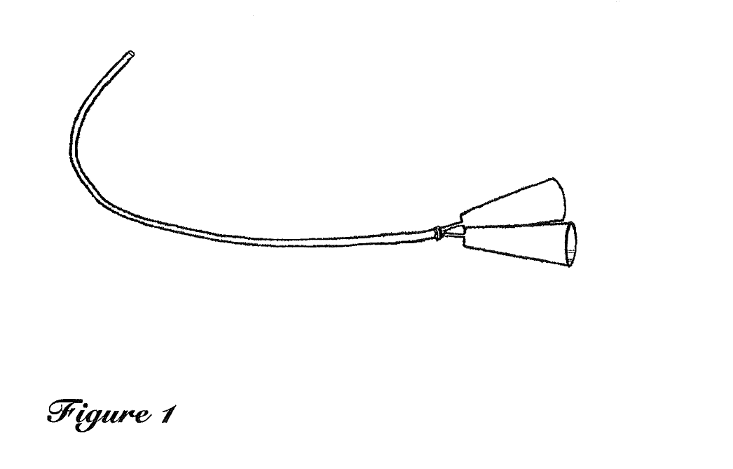

c) directing the two precipitation components as jets of metal ions and alkaline solutions with equal volume flow to impinge into each other in a mixing unit at a speed of ca 8 m/s. FIG. 1 shows the mixer unit.

d) directing the mix from the mixing unit immediately through a hose to the container connected to the AC magnetic susceptometer,

e) recording the evolution of the magnetic properties of the precipitated particles in real time, during the entire course of the precipitation reaction, as the particles develop,

f) terminating the real time measurement as in-phase and out-of-phase susceptibility stabilize at constant values.

The following example is intended only to further illustrate the invention and is not intended to limit the scope of the invention that is defined by the claims.

### EXAMPLE

The diameter of the two jets is 0.19 mm, and the mixing unit is realized by two steel tubes with inner diameters of ca 0.2 mm inserted in one end of a ca 15 cm long Teflon tube with approximately 0.5 mm inner diameter. The tubes tips are directed onto each other. FIG. 1 shows the mixer unit without the hoses supplying the metal ion and base solution. Starting materials can be commercial FeCl₂*4(H₂O) 99% (Alfa-Aesar), FeCl₃*6(H₂O) 98% (Aldrich), 25% NH₃ or NaOH of reagent grade and deionized water. The relation between [Fe²⁺] and [Fe³⁺] is 1:2 in the prepared metal ion solution, corresponding to Fe₃O₄. All experiments were conducted at room temperature.

The rapid mixing (RM) reaction is realized by letting the two jets of iron ion and alkaline solutions, with equal volume flow, to impinge into each other at a speed of ca 8 m/s. The reactants are discharged by 1 mL syringes filled with 100 μL each. At the time of mixing, the syringes are simultaneously pressed by means of a pneumatic cylinder. The discharge takes 0.45 seconds. The relevant time scale for mixing can be estimated to be of the order millisecond.

After charging the syringes, the narrow plastic tube is arranged with its end at the bottom of the sample vial in the susceptometer. The lock in amplifier is balanced to null any off-balance and contribution from the sample vial. The data reading software is then started. 12 seconds later the two syringes are simultaneously discharged. The data software reads data uninterrupted until stopped by the operator. The frequency of the exciting magnetic field was 2 kHz and field strength 600 A/m.

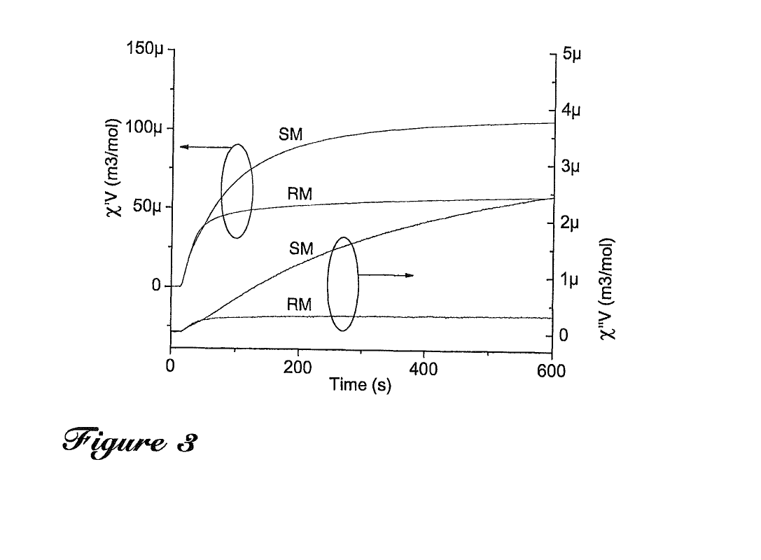

To demonstrate the importance of continuous monitoring during aqueous co precipitation reactions, and the effect the rate of mixing has on the development of the magnetic response, it is shown in FIG. 3 the magnetic susceptibility measurements from both a RM and a SM precipitation with ammonia. The slow mix (SM) was realized by that the two constituents were discharged in sequence into the sample vial, however in total not requiring longer time than the rapid mix, ca 1 second, which was identified as an approximate time scale for the mixing typically described in the present literature. Equal volumes of iron ion solution with a total ion concentration of 0.2 M were mixed with 2 M ammonia solution.

There are two major differences between the two situations. RM results in a development of in-phase susceptibility and a simultaneous but much weaker out-of-phase susceptibility, mostly completed within one minute. The out-of-phase susceptibility has at this stage increased to ca 0.5% of the in-phase susceptibility. SM results in an initially rather similar development of the susceptibility. However, the reaction does not finish as the RM does after ca 1 minute, but continues for a much longer time. Even after ten minutes there is yet a steady increase of the out-of-phase susceptibility, at this point constituting ca 2.5% of the in-phase susceptibility.

The same measurements have also been performed with sodium hydroxide as the alkaline precipitation medium (0.2 M iron ion, 1 M NaOH). In general, the reactions are much slower. However, the overall picture of the difference between RM and SM is the same; RM yields a quicker reaction with a distinctively lower fraction of out-of-phase susceptibility.

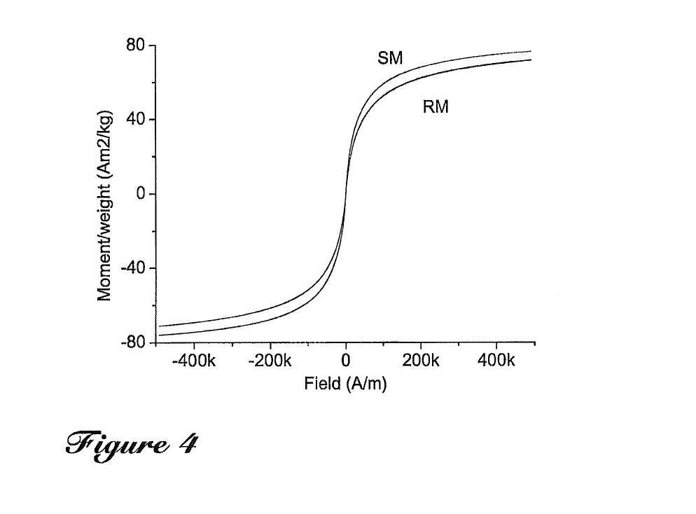

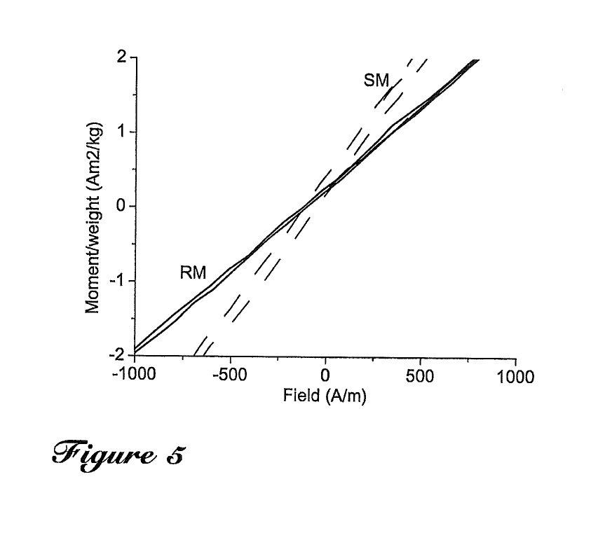

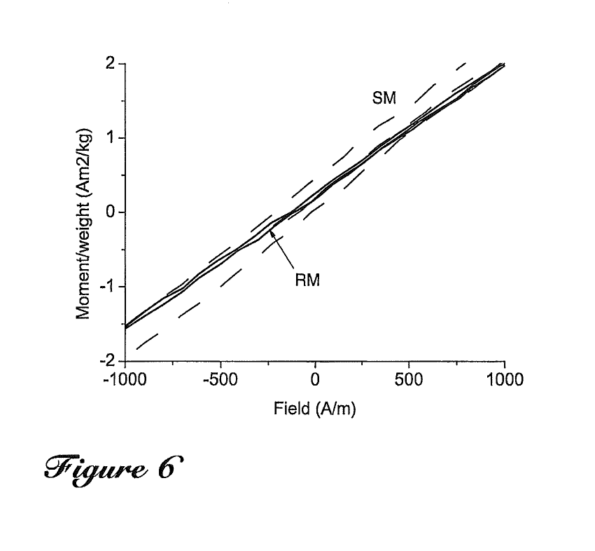

Measurements in strong fields confirm the difference between the courses of the precipitation reactions. Hysteresis loops up to maximum field strength of 500 kA/m were acquired from VSM experiments. Both RM and SM samples precipitated with ammonia show typical ‘Langevin-like’ loops with very slight coercivity, FIG. 4. However, magnification around origin displays distinct differences. The RM sample has a coercivity of Hc=8.5 A/m, whereas the SM sample has a coercivity of Hc=33.5 A/m (a factor of 4 larger), due to larger particles. The same mixing rate comparison with sodium hydroxide as precipitation medium shows similar results FIG. 5-6. Noteworthy are the quite large numbers for magnetization; 72 and 76 Am²/kg for RM and SM, which are not far from the bulk value (ca 90 Am²/kg), in particular when considering the small particle sizes, 6.4 and 7.4 nm respectively.

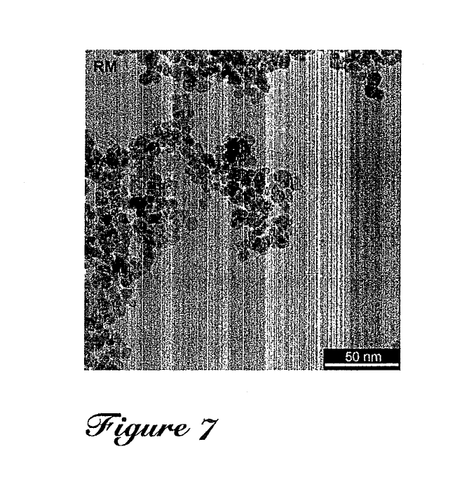

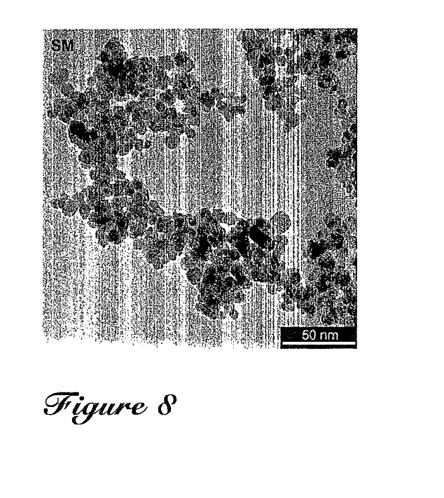

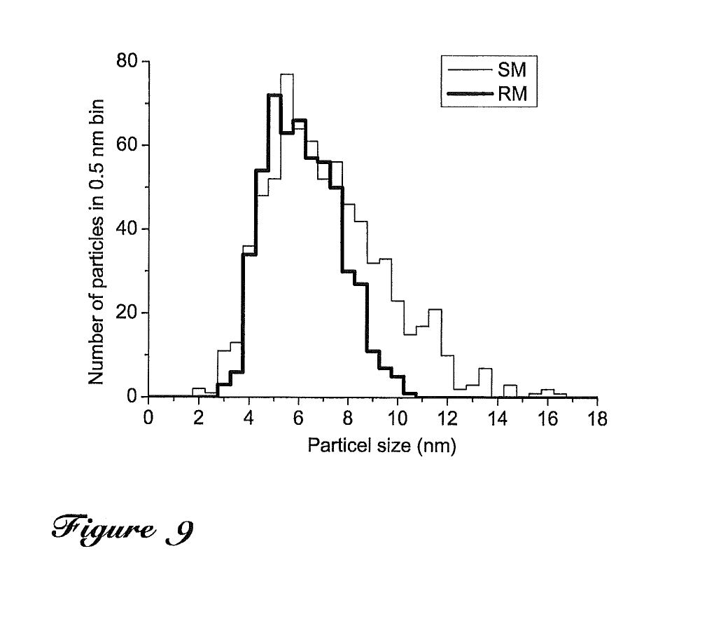

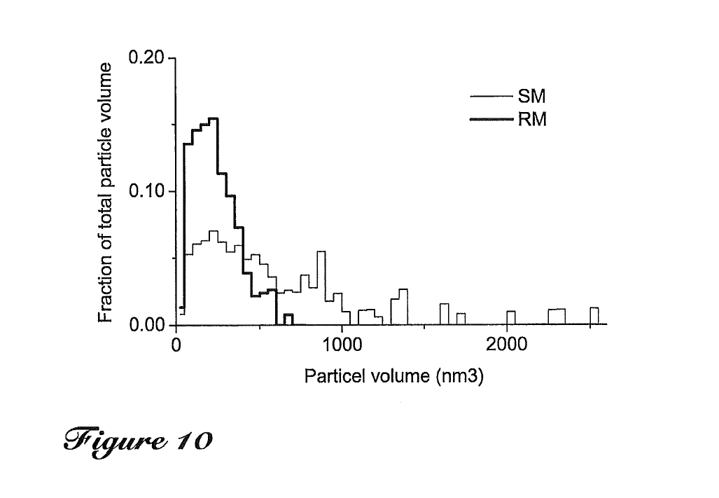

Transmission electron micrographs (TEM) show the effects of RM FIG. 7 and SM FIG. 8. Although the figures are similar, the difference in particle size distribution between RM and SM is quantitatively different; i.e. the determined size of 500+ particles for both RM and SM (ammonia reacted) showed that the number mean size is 6.4 nm for RM and 7.4 nm for SM, FIG. 9. The distribution difference is even more apparent if calculated as a volume distributions FIG. 10; the RM sample particles has a volume mean of 239 nm³ compared to 620 nm³ for SM.

The size distribution for RM particles has a standard deviation of 134 nm³ and the SM particles 522 nm³. Thus the size distribution for the RM particles is rather narrow compared to the SM particles. It is appropriate to emphasize that in many, if not most, situations and applications it is the volume distribution rather than the number distribution, which is the most informative, since it describes how the total amount of material is distributed among the sizes.

With the described experimental arrangement, it is demonstrated the fundamental effect the rate of mixing has on co-precipitation of magnetite and the importance of continuous reaction monitoring. The major difference between RM and SM is the continuously rising in-phase and out-of-phase magnetic susceptibility for the SM particles even after the first minute. The slower reaction is identified as related to phase retransformation or an ageing process. RM does not require aging, so the reaction is quicker and the particle size distribution remains unperturbed and more narrow. From precipitation experiments with sodium hydroxide instead of ammonia it is observed that the reactions are about one order of magnitude slower. However, also here, the RM particles are different from the SM particles, see FIG. 6., even though the time scale for the entire reaction is of the order hours, the reaction route is sensitive to the first milliseconds after mixing, which indicates the same mechanism for the mixing rate effect as for the reaction with ammonia.

In conclusion it is demonstrated that a sufficiently high mixing rate in co-precipitation of magnetite yields smaller particle size, more narrow size distribution and an overall much faster reaction negating the need for aging. Magnetization values are among the highest reported for magnetite nanoparticles. An essential part of the experimental arrangement is the capability to measure the evolution of the magnetic response during the reaction.

Although the present invention has been described in considerable detail with reference to certain embodiments, one skilled in the art will appreciate that the present invention can be practiced by other than the described embodiments and examples, which has been presented for purpose of illustration and not limitation. Therefore, the scope of the appended claims should not be limited to the descriptions of the examples contained herein.

1. A process methodology for producing magnetic nanoparticles of uniform shape and size under very rapid mixing conditions within an experimental set-up allowing simultaneous reaction progress evaluation of magnetic nanoparticle data, comprising:
a. forming one or more aqueous solutions of the metal ions, where the metal ions in the solution are present as hydrated metal ions, metal hydroxides, metal oxy-hydroxides, metal oxides or the alike metal complexes formed in aqueous solutions that can be chemically transformed into magnetic nanoparticles under favourable pH and redox potentials;
b. very rapidly mixing the solution(s) with one or more aqueous alkaline solution(s) within a mixing unit that continuously allow the components to impinge into each other at high speed; and
c. leading/directing the mixture of the solutions within a tube/hose from the mixing unit to a compartment in a magnetic suceptometer in order to measure the in-phase and out-of-phase susceptibility during the course of the precipitation reaction to monitor and evaluate the reaction conditions in real time.

2. The method of claim 1 wherein the metal ions in the solution(s) in step (a) are selected from the coordination compounds including divalent or trivalent atoms from the d-block elements in the periodic table such as Co²⁺, Fe²⁺, Mn²⁺, Fe³⁺ or metal ion hydroxide complexes or metal ion oxide complexes and the stoichiometric relation between the metal ions/ion complexes of different ions are in the range of 1:1.5 to 1:2.5, in particular 1:2—corresponding to the stoichiometric content of the metal ions in ferrite materials.

3. The method of claim 1 wherein the alkaline solution(s) in step (b) is chosen from NaOH, KOH, LiOH, NH₃ and the like, with an initial pH prior to the reaction above 10, providing a pH above 8.0 after mixing with the metal ion solutions.

4. The method of claim 1 wherein the alkaline solution in step (b) comprises NaOH or NH₃ and a mild oxidation agent.

5. The method of claim 1 wherein the alkaline solution in step (b) comprises KNO₃ as a mild oxidation agent.

6. The method according to claim 1 wherein the liquids prior to mixing are temperature controlled so the mixing is taking place at a well defined temperature between the freezing temperature and boiling temperature of the liquids, and that the tube/hose system downstream to the mixing is temperature controlled at a temperature different or the same compared to the temperature prior to mixing but within the limits given, i.e. freezing and boiling temperatures.

7. The method according to claim 1 wherein the rapid mixing is characterized by that the mixing time is ca lms or less the mixing time being defined as the time required for the liquid to travel 3 tube diameters after the point of mixing, e.g. in tubes with diameters from ca 0.2 mm to ca 0.5 mm, the mean liquid velocities in the range 8-2 m/s have the corresponding mixing times in the range 0.125 ms to 0.8 ms.

8. The method according to claim 1 wherein the mixing rate is sufficiently high to show a markedly more narrow size distribution for precipitated magnetic nanoparticles as compared to a slow mix where the corresponding mixing time is in the range of a second, i.e. a more than 30% reduction of the standard deviation of an average particle size, as determined from a minimum of 500 measured nanoparticles.

9. The method according to claim 1 (c) wherein recorded variations in in-phase and out-of-phase susceptibility are terminated within 5 min after the mixing of the solutions.

10. The method of claim 1 wherein step (c) is performed until the in-phase and out-of-phase susceptibility measurements have stabilized and no further change in magnetic susceptibility is recorded.

11. The method according to claim 1 wherein the experimental set-up includes a sufficiently long tube/hose system directing/leading the reaction mixture into the susceptometer, the tube/hose length and diameter are adjusted according to the total volume flow, such that the precipitation reaction has time to finish inside the tube/hose system (as determined by the change in in-phase and out-of-phase susceptibility at different positions of the tube/hose system) i.e. no difference in in-phase and out-of-phase susceptibility is recorded upon exit of particles from the tube/hose system compared to a position significantly before the exit.

12. The method according to claim 1 wherein the tube/hose systems with salt solutions/particles are exposed to ultra sonic and/or microwave radiation prior to mixing and/or after the mixing, i.e. during the course of growth of the precipitated nanoparticles inside the tube/hose.

13. The method according to claim 1 wherein the magnetic particles are coated with a polymeric substance containing silicone, titanium or carbon substances in the immediate vicinity of the rapid mixing inside the tube/hose leading the mixture (step (c) claim 1) from the mixing stage.

14. The method according to claim 1 where the precipitated particles comprises one or more of the following criteria:
a. the particles exhibit ferri/ferro magnetism, as determined by hysteresis loop behaviour;
b. the particles exhibit superparamagnetism, as determined by Langevin like hysteresis loop behaviour;
c. the particles can be characterized as spinel phase by X-ray diffraction;
d. the particles have an average particle size larger than 0.1 nm but smaller than 100 nm;
e. the particles in particular have an average particle size larger than 3 nm but smaller than 25 nm.
f. the particles have a spherical, cubical or octahedral form;
g. the particles show a more than 5% smaller average size (diameter) as a result of the rapid mixing methodology;
h. the particles show a more than 40% reduction in mean volume distribution as a result of the rapid mixing methodology; and
i. the particles show a more than 50% reduced standard deviation of the volume distribution of the particles as a result of the rapid mixing methodology.
